(19) United States
(12) Patent Application Publication
(10) Pub. No.: US 2019/0090311 A1
(43) Pub. Date: Mar. 21, 2019

(54) VIRTUAL NETWORK SYSTEM, MANAGEMENT DEVICE, AND VIRTUAL NETWORK MANAGEMENT METHOD

(71) Applicant: NEC CORPORATION, Tokyo (JP)

(72) Inventors: Masanori TAKASHIMA, Tokyo (JP); Shuichi SAITO, Tokyo (JP)

(73) Assignee: NEC CORPORATION, Tokyo (JP)

(21) Appl. No.: 16/085,320

(22) PCT Filed: Jun. 21, 2017
(86) PCT No.: PCT/JP2017/022853

§ 371 Date: Sep. 14, 2018

(30) Foreign Application Priority Data
Jun. 24, 2016 (JP) 2016-125200

(51) Int. Cl. H04W 88/10; H04W 12/06; H04W 48/18; H04W 88/16; H04W 8/18; H04L 12/46

(52) U.S. Cl. CPC H04W 88/10; H04W 12/06; H04L 12/4641; H04W 88/16; H04W 8/183; H04W 48/18

(57) ABSTRACT

The present invention enables simplification of a setting operation when various services are provided via an MVNO. A virtual network system is provided with a first device, a second device, and a third device. The first device utilizes a mobile communication service provided by a mobile virtual network operator to authenticate a user terminal that accesses a first physical network. The second device permits the user terminal that has been successfully authenticated to access, via a virtual network configured in a second physical network, a virtual network of the first physical network in accordance with the result of the authentication. The third device sets information concerning the user terminal in the first and the second device.

### TECHNICAL FIELD

The present invention relates to a technique of a virtual network system using Mobile Virtual Network Operator (hereinafter also referred to as MVNO) service.

### BACKGROUND ART

Patent Literature 1 discloses an example of a technique for automatically enabling opening a line of a communication terminal. According to Patent Literature 1, a vending machine of a communication opening system has a vending machine side communication unit for sending an identity number of a purchased Subscriber Identity Module (SIM) card and personal information of the person who purchases the SIM card to the data center. On the other hand, the data center of the communication opening service has a data center side control unit for opening the line corresponding to the identification number in the case the information necessary for opening the communication terminal to which the SIM card is inserted is included in the receive personal information.

Patent Literature 2 discloses a Packet Data Network Gateway (PGW) device of a mobile communication system including a PGW, a Diameter Routing Agent (DRA) and a plurality of Policy and Charging Rules Function (PCRF) devices. The PGW device of Patent Literature 2 is a PGW device that is able to suppress communication or the amount thereof related to service requests between the PGW and DRA that causes to increase the network traffic and processing load of the DRA. Specifically, the PGW device includes a memory to which at least one Access Point Name (APN) and a PCRF device are related and registered. Moreover, the PGW device includes a controlling device for sending a user a request of policy information to the PCRF device to which the APN in the predetermined signal received from the user is related in the memory.

Patent Literature 3 discloses an architecture for enabling development of an own-brand wireless product by a Mobile Virtual Network Operator (MVNO).

Non Patent Literature 1 is a white paper related to the Network Functions Virtualization (NFV).

### CITATION LIST

### Patent Literature

[PTL 1] Japanese Unexamined Patent Application Publication No. 2015-130593
[PTL 2] Japanese Unexamined Patent Application Publication No. 2015-195438
[PTL 3] Japanese Unexamined Patent Application Publication (Translation of PCT Application) No. 2013-505516

### Non Patent Literature

[NPL1] European Telecommunications Standards Institute (ETSI), “Network Functions Virtualization—Update White Paper”, [online], Searched on May 11, 2017, Internet <URL:https://portal.etsi.org/NFV/NFV_White_Paper2.pdf>

### SUMMARY OF INVENTION

### Technical Problem

The following is the analysis by the inventor. Communication services by MVNO and Mobile Virtual Network Enabler (MVNE) are starting to spread as the communication and access fee significantly decreases and the network functions of Mobile Network Operator (MNO) are released (layer 2 connection function started to be provided). One of the reasons of prevention of spread of MVNO is said to be the complicated opening work (refer to the background art in Patent Literature 1). In Patent Literature 1, when a SIM card is purchased, the SIM card vending machine sends the personal information to the data center side, and then the data center performs the opening processing. The MVNO and MVNE are defined as follows, according to the Guidelines for Application Relationship between the Telecommunications Business Act and the Radio Act issued by Telecommunications Bureau of Ministry of Internal Affairs and Communications of Japan. MVNO is defined as a telecommunications carrier that provides a mobile communication service using a mobile communication service provided by an MNO or by connecting to the MNO, and does not open or operate a wireless station related to the mobile communication service. Additionally, an MVNE is defined as those who run a business that supports an establishment of a business of an MVNO based on a contract with the MVNO.

In the future, layer 2 connection that enables MVNO operator to directly operate Gateway GPRS (General Packet Radio Service) Support Node (GGSN) and PGW is considered to widely spread, and various services are considered to be provided. In this case, linking of MVNO users on the base station (data center) side and the service (specifically the virtual network used by the user) becomes a problem. In other words, when the technique of Patent Literature 1 is used, the user cannot immediately use the service provided by the MVNO operator side. Moreover, in the technique of Patent Literature 1, a work to link the user and the service is necessary.

The technique in the Patent Literature 2, by preliminarily storing the correspondence of the APN (user) and the PCRF on the PGW side, can only omit an inquiry to a DRA performed when the PGW selects a PCRF.

The major objective of the present invention is to provide a technique that contributes to saving the labor of setting work related to the virtual network system when various services are provided via MVNO.

### Solution to Problem

According to a first aspect, a virtual network system as follows is provided.

The virtual network system includes:

a first physical network in which a plurality of virtual networks are constructed;

a base station of a Mobile Virtual Network Operator that provides a communication service using a mobile communication service provided by a mobile network operator to a user terminal;

a second physical network that connects the first physical network and the base station of the Mobile Virtual Network Operator;

a first device that authenticates a user terminal to access to the first physical network using the mobile communication service provided by the Mobile Virtual Network Operator;

a second device that authorizes the user terminal that succeeded in the authentication to access to a virtual network in the first physical network according to the authentication result via a virtual network constructed in the second physical network; and

a third device that sets information related to the user terminal to the first device and the second device.

According to a second aspect, a management device as follows is provided.

The management device is arranged in a virtual network system that includes: a first physical network in which a plurality of virtual networks are constructed; a base station of a Mobile Virtual Network Operator that provides a communication service using a mobile communication service provided by a mobile network operator to a user terminal; and a second physical network that connects the first physical network and the base station of a Mobile Virtual Network Operator.

In the management device, information related to a user terminal to access to the first physical network using a mobile communication service provided by the Mobile Virtual Network Operator is set to a first device and a second device. The first device authenticates the user terminal. The second device authorizes access by the user terminal succeeded in the authentication to a virtual network in the first physical network according to the authentication result via a virtual network constructed in the second physical network.

According to a third aspect, a management method of a virtual network as follows is provided.

The management method of a virtual network includes:

by a management device of a virtual network system,

setting information about a user terminal to a first device and a second device. The first device authenticates the user terminal to access to a first physical network using the mobile communication service provided by the Mobile Virtual Network Operator. The second device authorizes the user terminal that succeeded in the authentication to access to a virtual network in the first physical network according to the authentication result via a virtual network constructed in the second physical network.

The virtual network system includes: the first physical network in which a plurality of virtual networks are constructed; a base station of the Mobile Virtual Network Operator that provides a communication service using the mobile communication service provided by a mobile network operator to the user terminal; and the second physical network that connects the first physical network and the base station of the Mobile Virtual Network Operator.

The management method is related to a specific machine that is a management device to control access to the virtual network.

According to a forth aspect, a program storage media (non-transitory storage media) as follows is provided.

The program storage media stored a computer program causing a computer to set information about a user terminal to a first device and a second device. The first device authenticates the user terminal to access to a first physical network using the mobile communication service provided by the Mobile Virtual Network Operator. The second device authorizes the user terminal that succeeded in the authentication to access to a virtual network in the first physical network according to the authentication result via a virtual network constructed in the second physical network.

The virtual network system includes: the first physical network in which a plurality of virtual networks are constructed; a base station of the Mobile Virtual Network Operator that provides a communication service using the mobile communication service provided by a mobile network operator to the user terminal; and the second physical network that connects the first physical network and the base station of the Mobile Virtual Network Operator.

The program storage media can be embodied as a computer product.

### Advantageous Effects of Invention

The present invention enables to contribute to saving the labor of setting work when providing various services via MVNO.

### BRIEF DESCRIPTION OF DRAWINGS

FIG. 1 is a diagram illustrating a configuration of an example embodiment of the present invention.

FIG. 2 is a diagram describing an operation of an example embodiment of the present invention.

FIG. 3 is a diagram describing an operation of an example embodiment of the present invention.

FIG. 4 is a diagram describing an operation of an example embodiment of the present invention.

FIG. 5 is a diagram illustrating a configuration of the virtual network system according to the first example embodiment of the present invention.

FIG. 6 is a diagram illustrating a configuration of a management device according to the first example embodiment of the present invention.

FIG. 7 is a diagram illustrating an example of information maintained by the management device according to the first example embodiment of the present invention.

FIG. 8 is a flow chart illustrating an example of an operation of the management device according to the first example embodiment of the present invention.

FIG. 9 is a diagram describing an operation of the virtual network system according to the first example embodiment of the present invention.

FIG. 10 is a diagram describing an operation of the virtual network system according to the first example embodiment of the present invention.

FIG. 11 is a diagram describing an operation of the virtual network system according to the first example embodiment of the present invention.

FIG. 12 is a diagram describing an operation of the virtual network system according to the first example embodiment of the present invention.

FIG. 13 is a diagram illustrating a configuration of the virtual network system according to a second example embodiment of the present invention.

FIG. 14 is a diagram for describing an operation of the virtual network system according to the second example embodiment of the present invention.

### EXAMPLE EMBODIMENT

With reference to the figures, an overview of an example embodiment of the present invention is described. Note that the reference numerals are given to elements for convenience as an example to help understanding, and are not intended to limit the present invention to the illustrated embodiments.

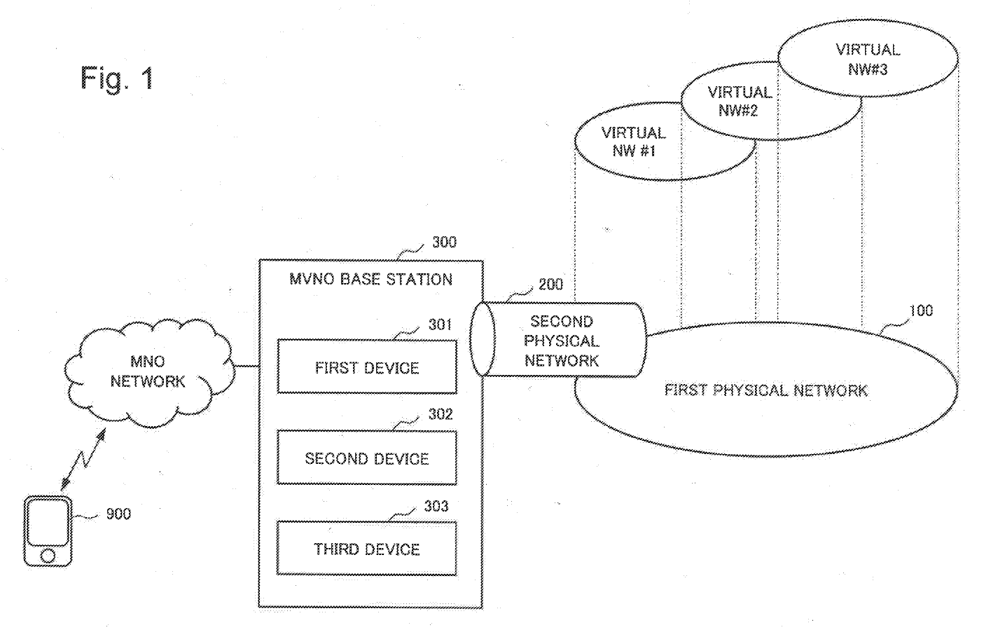

As illustrated in FIG. 1, a virtual network system according to an example embodiment of the present invention can be realized with a configuration including a first physical network 100, a second physical network 200 and a base station 300 of a Mobile Virtual Network Operator (MVNO base station). The first physical network 100 is a physical network in which a plurality of virtual networks are constructed. The base station 300 is a base station of the Mobile Virtual Network Operator that provides, to the user terminal 900, a communication service using a mobile communication service provided by a mobile network operator. The second physical network 200 is a physical network that connects the first physical network 100 and the base station 300 of the Mobile Virtual Network Operator.

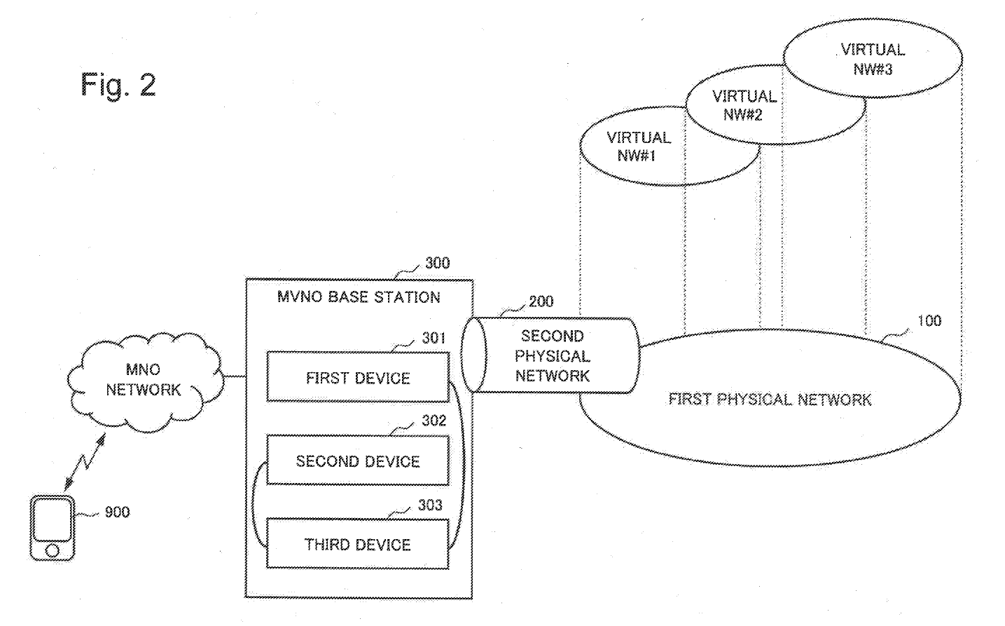

The virtual network system further includes a first device 301, a second device 302 and a third device 303. Specifically, the third device 303 sets information about the user terminal 900 to the first and second device, as illustrated in FIG. 2.

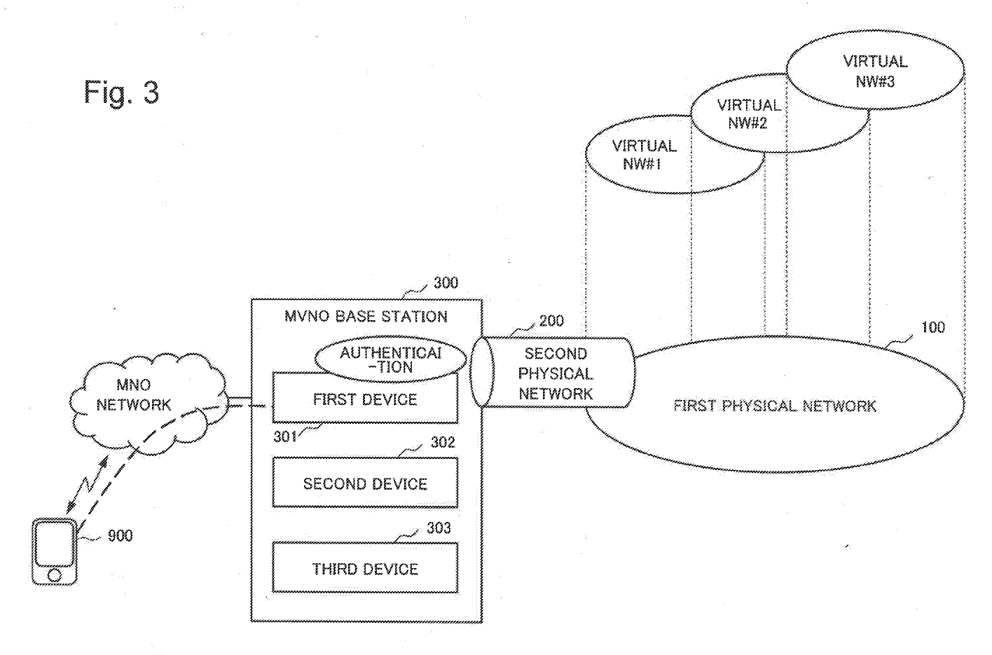

The first device 301 authenticates the user terminal 900 that requests access to the first physical network 100 using the mobile communication service provided by the Mobile Virtual Network Operator based on the information set by the third device 303, as illustrated in FIG. 3.

The second device 302 authorizes access to the virtual network in the first physical network 100, to the user terminal 900 that succeeded in the authentication by the first device 301. The user terminal 900 that has been authorized access accesses to the virtual network in the first physical network 100 via the virtual network constructed in the second physical network 200. The virtual network in the first physical network 100 in which the second device 302 authorizes access by the user terminal 900 is the virtual network based on the authentication result by the first device 301.

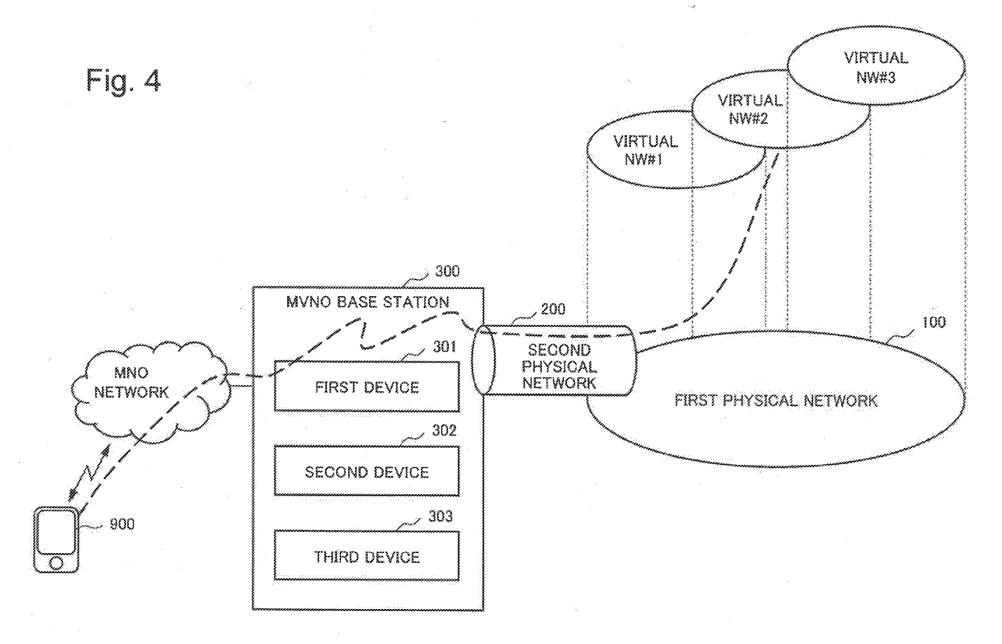

For example, the second device 302 authorizes access to the virtual network (virtual NW) #2 to the user terminal 900 based on the information set by the third device 303 (refer to FIG. 4).

The virtual network system of the above-described example embodiment can contribute to saving the labor of setting work when providing various services via MVNO. The reason is that the first device 301 to third device 303 are arranged on the base station 300 of the Mobile Virtual Network Operator, and the devices 301 to 303 are configured to set matters necessary for the user terminal 900 to access the virtual network.

### First Example Embodiment

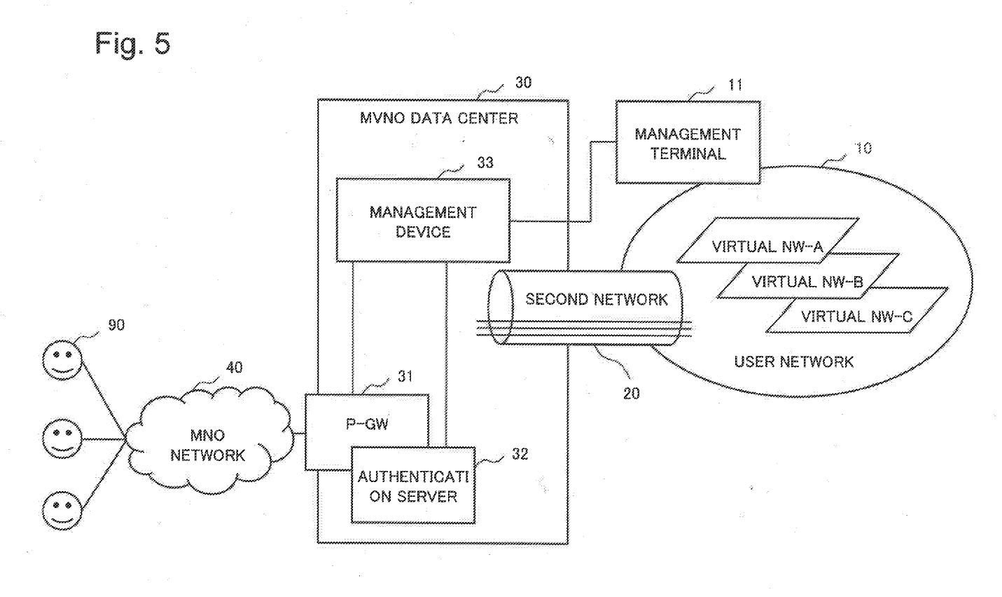

With reference to the figures, the first example embodiment of the present invention will be described in detail. FIG. 5 is a diagram illustrating a configuration of the virtual network system according to the first example embodiment. In FIG. 5, a configuration in which an MVNO data center 30 that provides a communication service to a user terminal 90 using a Mobile Network Operator (MNO) network 40 and a user network 10 are connected via a second network 20.

The user network 10 is a network arranged in an organization, such as an enterprise or a school, to which a user of the user terminal 90 belongs. In the user network 10, virtual networks A to C (virtual NW-A to virtual NW-C) are configured using a virtualization technique. In the first example embodiment, the user network 10 corresponds to the above-described first physical network. A smart meter, various sensor devices, or an Internet of Things (IoT) device such as an information household electrical appliance may be connected to the user network 10.

In the user network 10, a management terminal (network management terminal) 11 that receives instructions by a network manager is arranged. The management terminal 11 is arranged in a Network Operation Center (NOC) in the user network 10, and the manager of the user network 10 can operate the management terminal. Note that a place to arrange the management terminal 11 is not limited to the user network 10, but the management terminal 11 may be a remote terminal connected to the user network 10 via the MNO network 40.

The MVNO data center 30 includes a Packet Data Network Gateway (P-GW) 31, authentication server 32 and the management device 33, and provides an environment for the user terminal 90 to connect to the virtual NW-A to virtual NW-C that are constructed on the user network 10. In the first example embodiment, the MVNO data center 30 corresponds to the above-described base station of the Mobile Virtual Network Operator.

The second network 20 is configured by a dedicated line, a Virtual Private Network (VPN), or the like that connects between an access point of the user network 10 and the network on the MVNO side beyond the P-GW 31. The second network 20 corresponds to the above-described second physical network.

The user terminal 90 is a device such as a smartphone or a personal computer (PC) that can access to the user network 10 using the SIM card provided by the MVNO operator. Instead of the user terminal 90, an IoT device, an IoT-GW (Gateway) or the like may be connected with the user network 10.

Next, the details of the MVNO data center 30 are described. The P-GW 31 is a gateway that connects to a Serving Gateway (S-GW) on the MNO network 40 side using a tunneling protocol such as the General Packet Radio Switching Tunneling Protocol (GTP), and becomes a connecting point from the MNO network 40 to the user network 10. Note that, in the first example embodiment, the MNO network 40 uses the P-GW 31 since being a Long Term Evolution (LTE) network, however, when the MNO network 40 is a 3rd Generation (3G) network, the Gateway GPRS (General Packet Radio Service) Gene Support Node (GSSN) provides the equivalent functions. These exchange machines authorize the user terminal 90 to connect to the virtual network constructed on the second network 20 based on the authentication result received by the authentication server 32. In the first example embodiment, the P-GW 31 corresponds to the above-described second device. Of course, other gateway (GW) or exchange machine than the P-GW or GGSN may have a configuration that provides the equivalent function as the P-GW 31.

The authentication server 32 is a device that performs the authentication of the user terminal 90 in collaboration with the P-GW 31. Diameter Routing Agent (DRA), Remote Authentication Dial In User Service (RADIUS) and the like are the examples of the authentication server 32. In the first example embodiment, the authentication server 32 corresponds to the above-described first device.

The management device 33 notifies information about the user, the virtual network to which the user is authorized to access, the authentication and the like to the above-described P-GW 31 and the authentication server 32 based on the content (control information) supplied from the management terminal 11 arranged on the user network 10. The management device 33 also functions as a dashboard device that provides information about the setting content and the status of the virtual network to the management terminal 11. In the first example embodiment, the management device 33 corresponds to the above-described third device.

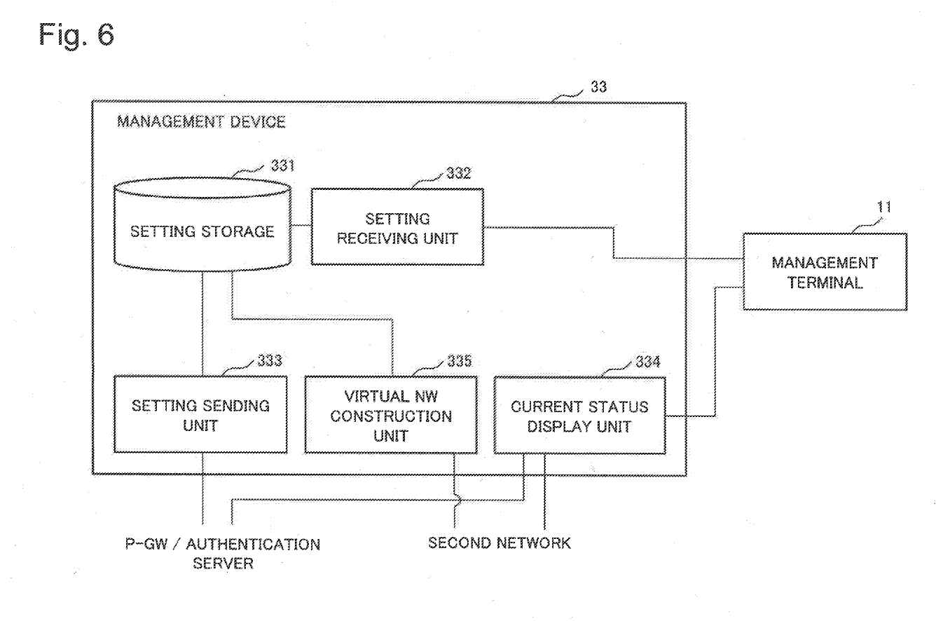

FIG. 6 is a diagram illustrating a configuration of the management device 33 according to the first example embodiment. In the example of FIG. 6, the management device 33 includes a setting storage 331, a setting receiving unit 332, a setting sending unit 333, a current status display unit 334 and a virtual NW construction unit 335.

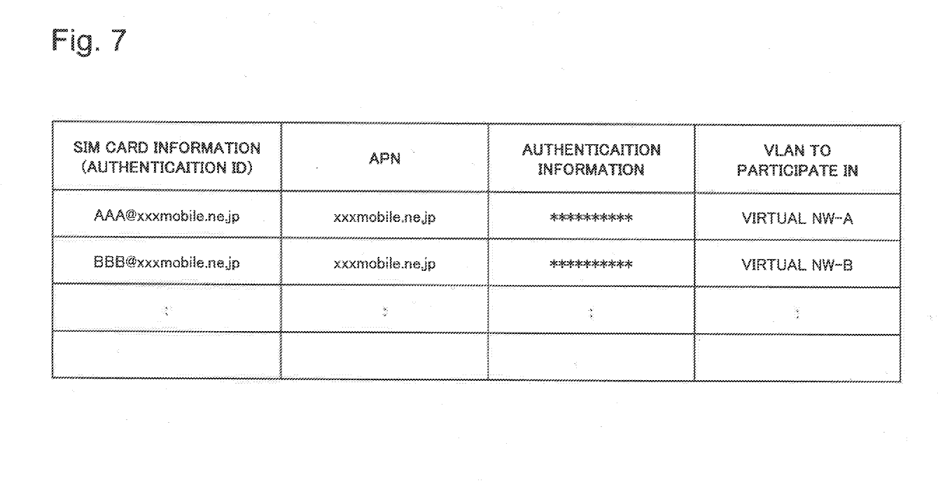

The setting storage 331 stores information to set to the P-GW 31 and the authentication server 32, in order to authorize the access to the virtual network constructed in the user network 10. FIG. 7 is a diagram illustrating an example of control information maintained by the management device 33. The example of FIG. 7 shows an entry in which authentication IDentification (ID) information in the SIM of each user terminal 90, APN information set to the user terminal 90, the authentication information (password, authentication method and the like), and the Virtual Local Area Network (VLAN) to participate in are related. For example, the first entry of FIG. 7 shows that a user who has an authentication ID of “AAA@xxxmobile.ne.jp” can connect to the virtual NW-A via the P-GW of the MVNO related to the APN named “xxxmobile.ne.jp”. Note that the number of virtual networks to which the user can connect may be two or more. Moreover, in this example, the authentication is performed using the authentication ID stored in the SIM card, but the authentication may be performed using the information stored in the SIM card such as International Mobile Subscriber Identity (IMSI).

The setting receiving unit 332 stores the control information in the setting storage 331 after receiving the control information input to the management terminal 11 based on the predetermined control information input screen displayed on display unit of the management terminal 11.

The setting sending unit 333 notifies the setting information registered to the setting storage 331 to the P-GW 31 and the authentication server 32, in response to a predetermined trigger.

The current status display unit 334 displays, when the information representing the current setting content and the status information of the virtual network is received from the P-GW 31, the received information on the screen and the like of the management terminal 11.

The virtual NW construction unit 335 constructs a virtual network corresponding to the virtual network (virtual NW-A to C) of the user network 10 in the second network 20 (the fourth device). The virtual networks corresponding to the virtual network (virtual NW-A to C) of the user network 10 can be realized by, for example, constructing virtual networks using VLAN IDs corresponding to the virtual networks (virtual NW-A to C) of the user network 10.

The MVNO data center and each unit of the management device (processing device) shown in FIG. 5 and FIG. 6 may be realized by a computer program causing a computer configuring the devices to execute the above-described processing using the hardware configuring the devices.

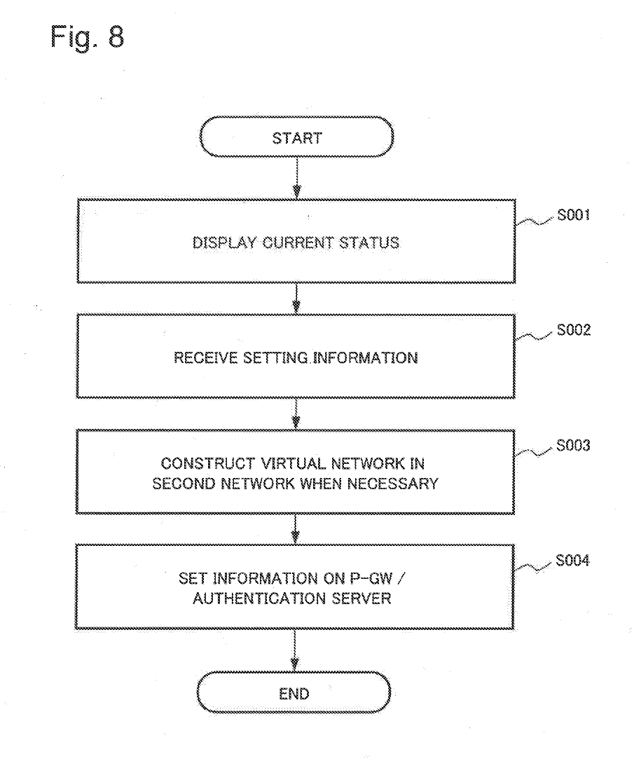

With reference to the figures, the operation of the first example embodiment will be described. FIG. 8 is a flow chart illustrating an example of an operation of the management device 33 according to the first example embodiment. Referring to FIG. 8, the management device 33 which is accessed from the management terminal 11 acquires the setting content of P-GW 31 and the status information of the virtual network via the current status display unit 334, and displays the acquired information on the display screen of the management terminal 11 (step S001). For example, the management device 33 displays the number of users set to the P-GW 31, the details thereof (refer to FIG. 7), the information of the virtual network structured on the second network 20 (VLAN ID and the correspondence with virtual NW-A to C).

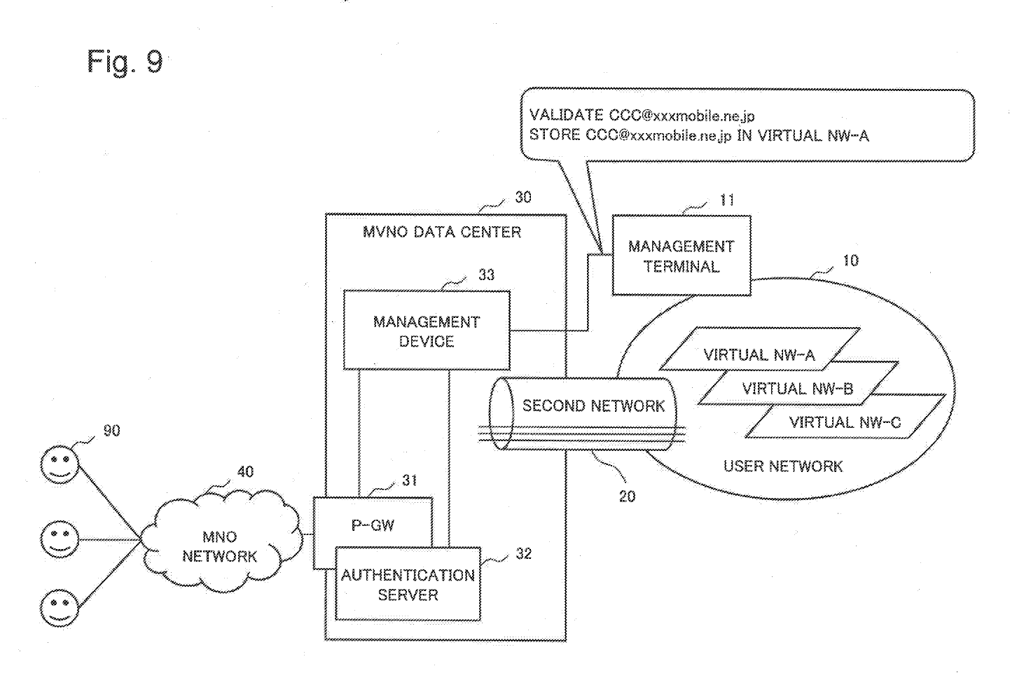

Then, the management device 33 receives the information to set to the P-GW 31 and the authentication server 32 from the management terminal 11 that is input to the management terminal 11 based on the control information input screen displayed on the management terminal 11 (step S002). For example, the management device 33 receives the SIM information (authentication ID), APN, authentication information, information of VLAN to participate in and the like of the user terminal 90 illustrated in FIG. 7 from the management terminal 11. In the example of FIG. 9, the management terminal 11 inputs, to the management device 33, that a user “CCC@xxxmobile.ne.jp” is validated (authentication information is set) and stored in the virtual NW-A.

Then, the management device 33 confirms whether the virtual network to which the user terminal 90 will be connected is structured in the second network 20 based on the information of the VLAN to participate in, and construct the virtual network in the second network 20, if necessary (step S003).

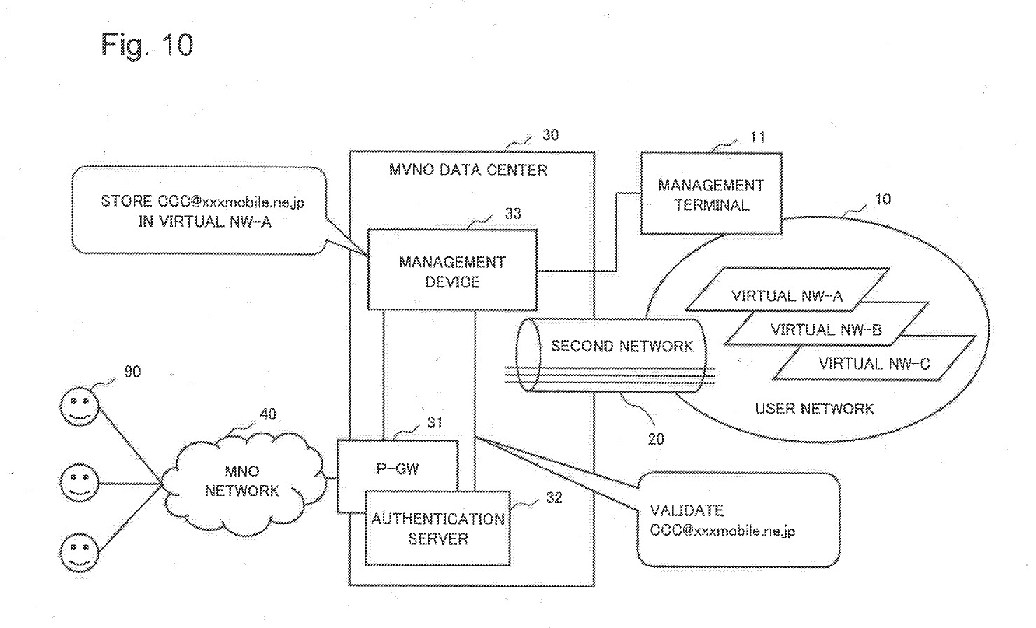

Then, the management device 33 sets the information received from the management terminal 11 to the P-GW 31 and the authentication server 32 (step S004). In the example of FIG. 10, the management device 33 notifies, to the P-GW 31, that the user “CCC@xxxmobile.ne.jp” is stored in the virtual NW-A. Similarly, the management device 33 notifies, to the authentication server 32, that the ID of the “CCC@xxxmobile.ne.jp” is validated (authentication information is set).

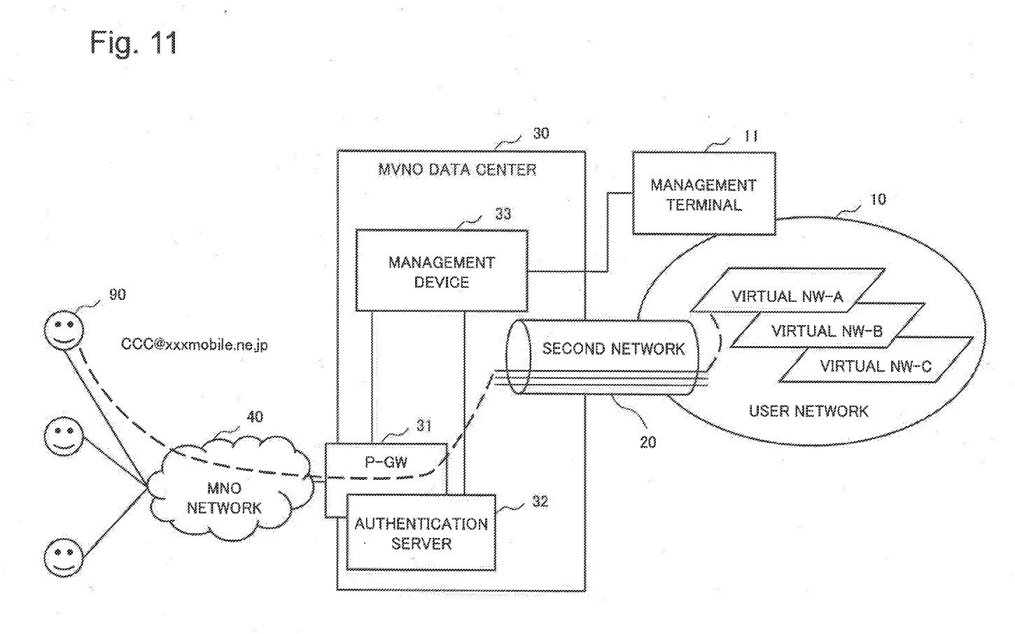

With the above processing, for example, as illustrated in FIG. 11, by the operation by the user “CCC@xxxmobile.ne.jp”, when the user terminal 90 accesses the MVNO data center 30 via the MNO network 40, a path to the P-GW 31 related to the APN is set. Thereafter, the P-GW 31 authenticates the user “CCC@xxxmobile.ne.jp” (user terminal 90) in collaboration with the authentication server 32, and when the authentication is succeeded, authorizes access by the user terminal 90 to the virtual NW-A via the related virtual network in the second network 20.

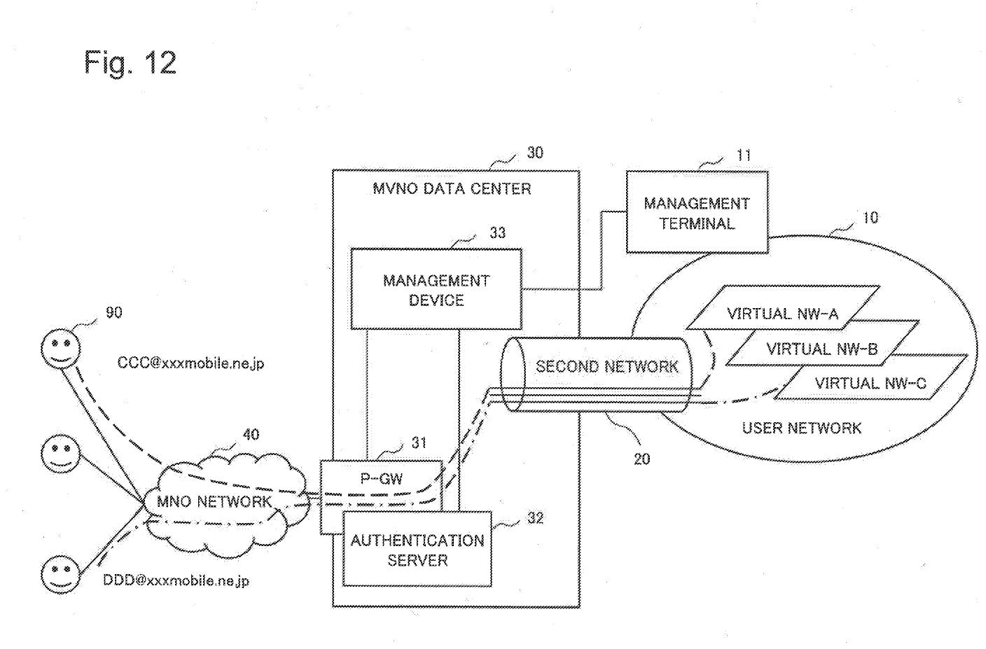

Similarly, the management device 33 sets, to the P-GW 31 and the authentication server 32, the information necessary for authorizing that the user terminal 90 operated by the user “DDD@xxxmobile.ne.jp” accesses the virtual NW-C in the user network 10. As a result, as illustrated in FIG. 12, the access by the user terminal 90 operated by the user “DDD@xxxmobile.ne.jp” to the virtual NW-C is authorized.

As described above, the virtual network system in the first example embodiment can authorize users having various attributes to selectively access the virtual network in the user network 10 by only inputting necessary information to the management terminal 11. Note that, as the APN and authentication information to set to the user terminal 90, an APN separately notified to each user and an initial password may be used.

### Second Example Embodiment

With reference to the figures, the second example embodiment of the present invention will be described in detail. In the description of the second example embodiment, the difference from the first example embodiment is described mainly, and the overlapping description of the part that is common with the first example embodiment is omitted.

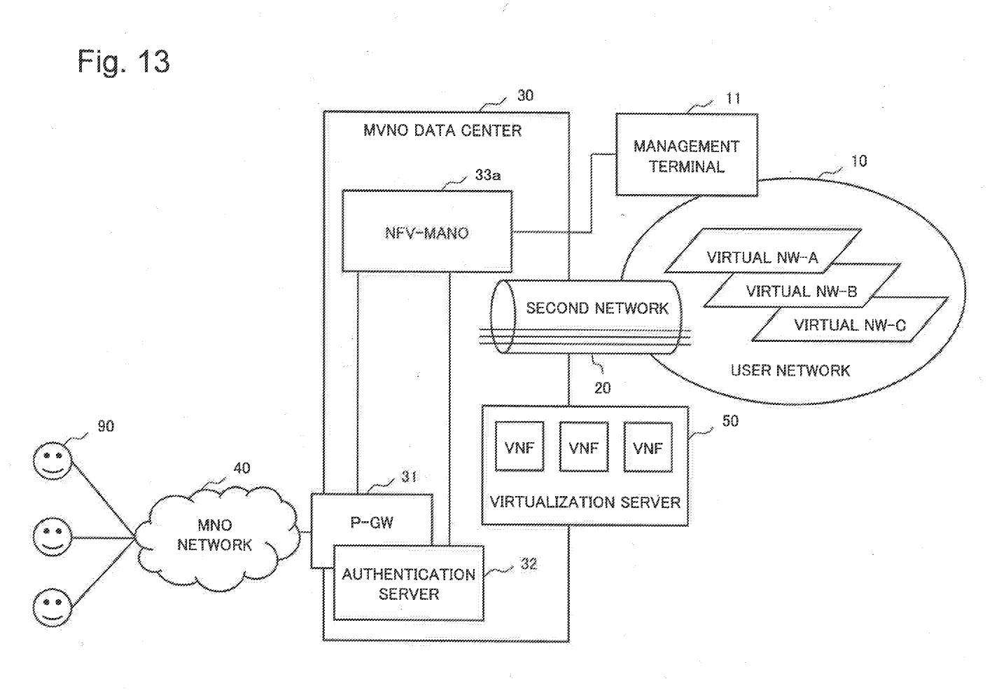

FIG. 13 is a diagram illustrating a configuration of the virtual network system according to the second example embodiment. The virtual network system of the second example embodiment includes a configuration enabling deployment of various network functions when necessary by adding a virtualization server to the MVNO data center 30. In the second example embodiment, a virtualization server 50 is added to the MVNO data center 30, and consequently, the management device 33 in the first example embodiment is replaced with Network Functions Virtualization—Management And Network Orchestration (NFV-MANO) 33a.

The NFV-MANO 33a orchestrates the Network Function Virtualization Infrastructure (NFVI) that is the execution platform of VNF constructed on the virtualization server according to an instruction from the management terminal 11 and VNF, in addition to functioning as the management device 33 in the first example embodiment. In other words, the NFV-MANO 33a functions as an orchestration device. A technique in Non Patent Literature 1 can be used as the NFV-MANO 33a.

The virtualization server 50 boots and provides to the user the instructed VNF in accordance with the orchestration from the NFV-MANO 33a.

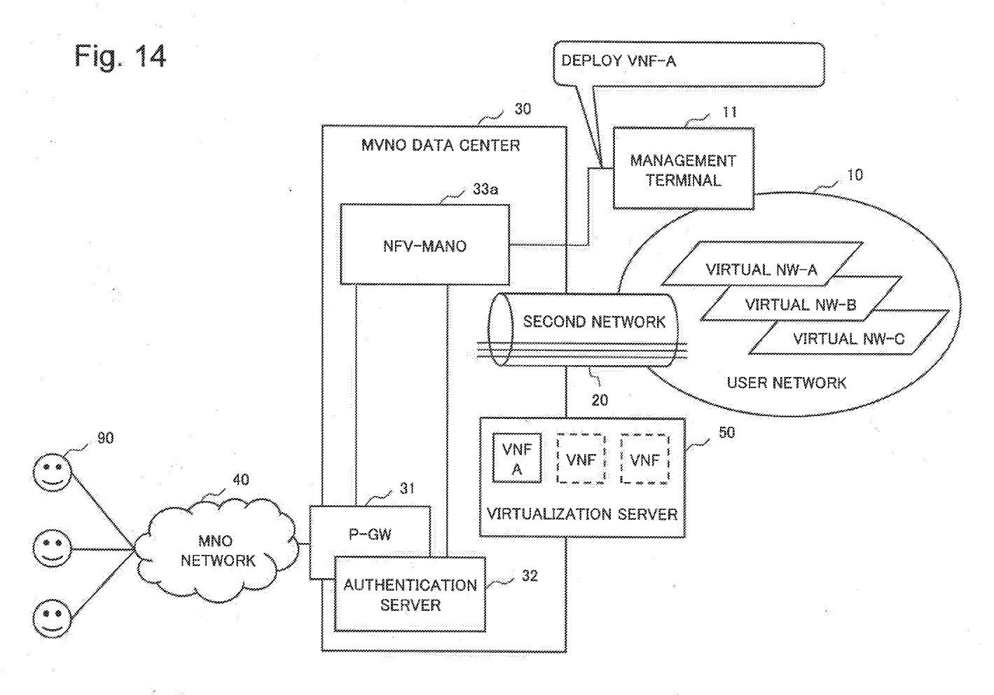

FIG. 14 is a diagram illustrating an operation of the second example embodiment. For example, when the management terminal 11 instructs the booting of the VNF-A (for example a router or an IoT gateway), the NFV-MANO 33a boots the VNF-A in the virtualization server 50. The VNF-A is set as available from a terminal and the like belonging to the virtual network designated by the management terminal 11.

In addition, the user terminal 90 may instruct the virtualization server 50 via the NFV-MANO 33a, and the above-described VNF may be booted. In this case, the user can boot the VNF-A that functions as the router or the IoT gateway when necessary, and can receive a service using the functions by sending an instruction to the virtualization server 50. For example, the VNF constructed on the virtualization server 50 is assumed to be the VNF corresponding to the IoT gateway that collects data sent from various IoT devices arranged in the virtual network in the user network 10, and performs statistical processing to the collected data. In this case, the user is able to view the data after the statistical processing and instruct further statistical processing by accessing the virtualization server 50 via the NFV-MANO 33a from the user terminal 90.

Hereinabove, the example embodiments of the present invention are described, however, the present invention is not limited to the above-described example embodiments. Further modification, replacement and adjustments can be applied without departing from the scope of the technical idea of the present invention. For example, the network configuration, the configuration of the elements, the expression of the messages illustrated on the diagrams are an example for helping understanding the present invention, and are not limited to the configuration illustrated in the diagrams.

The preferred embodiments of the present invention are summarized.

### First Embodiment

(Refer to the above-described virtual network system according the above-described first aspect.)

### Second Embodiment

The virtual network system according to the first embodiment, further including:

a fourth device that constructs, in the second physical network, a virtual network corresponding to a virtual network in the first physical network.

### Third Embodiment

The virtual network system according to the second embodiment, in which:

in addition to setting information related to the user terminal to the first and second device,

the third device notifies information in a Subscriber Identity Module (SIM) card of the user terminal to a gateway in the base station in the Mobile Virtual Network Operator having an access point name designated by the user terminal.

### Fourth Embodiment

The virtual network system according to one of the first to third embodiments,

further comprising a network management terminal for accepting a content to set to the third device from a network manager.

### Fifth Embodiment

The virtual network system according to the fourth embodiment, further comprising:

a virtualization server providing a virtual network function for each virtual network;

in which the virtual network function can be booted from the network management terminal or the user terminal via a predetermined orchestration device.

### Sixth Embodiment

(Refer to the management device according to the second aspect.)

### Seventh Embodiment

(Refer to the above-described management method of the virtual network according the above-described third aspect.)

### Eighth Embodiment

(Refer to the program according to the above-described fourth aspect.)

Note that the above-described sixth to eighth embodiments can be deployed to the second to fifth embodiments, in a similar way as the first embodiment.

Note that the each disclosure of the above-described Patent Literatures and the Non Patent Literature is incorporated by reference herein. In the scope of the entire disclosure (including claims) of the present invention, based on the basic technical idea thereof, modification and adjustment of the example embodiments and examples are possible. In addition, in the scope of the disclosure of the present invention, various combinations or selections of the disclosed elements (including elements in each claim, elements in each example embodiments, and elements in each diagrams) are possible. In other words, the present invention naturally includes various modifications and corrections that a person skilled in the art would have achieved in accordance with the entire disclosure and the technical idea including claims. Especially, for the numerical range described herein, it should be understood that any number or small range included in the range are understood as specifically described, even if it is not stated.

This application claims the benefit of Japanese Patent Application No. 2016-125200, filed on Jun. 24, 2016, the entire disclosure of which is incorporated by reference herein.

### REFERENCE SIGNS LIST

10 User network
11 Management terminal
20 Second network
30 MVNO data center
31 P-GW
32 Authentication server
33 Management device
33a NFV-MANO
40 MNO network
50 Virtualization server
90, 900 User terminal
100 First physical network
200 Second Physical network
300 Base station of Mobile Virtual Network Operator
301 First device
302 Second device
303 Third device
331 Setting storage
332 Setting receiving unit
333 Setting sending unit
334 Current status display unit
335 Virtual NW construction unit

1. A virtual network system comprising:
a first physical network in which a plurality of virtual networks are constructed;
a base station of a Mobile Virtual Network Operator that provides a communication service using a mobile communication service provided by a mobile network operator to a user terminal;
a second physical network that connects the first physical network and the base station of the Mobile Virtual Network Operator;
a first device that authenticates the user terminal to access to the first physical network using the mobile communication service provided by the Mobile Virtual Network Operator;
a second device that authorizes the user terminal that succeeded in the authentication to access to a first virtual network in the first physical network according to the authentication result via a second virtual network constructed in the second physical network; and
a third device that sets information related to the user terminal to the first device and the second device.

2. The virtual network system according to claim 1, further comprising a fourth device that constructs the second virtual network related to the first virtual network of the first physical network in the second physical network.

3. The virtual network system according to claim 1, wherein the third device notifies information in a Subscriber Identity Module (SIM) card of the user terminal to a gateway in the base station in the Mobile Virtual Network Operator having an access point name designated by the user terminal, in addition to the configuration for setting information related to the user terminal to the first device and the second device.

4. The virtual network system according to claim 1, further comprising a network management terminal that receives a content to set to the third device from a network manager.

5. The virtual network system according to claim 4, further comprising a virtualization server that provides a virtual network function for each virtual network,
wherein the virtual network function can be booted from the network management terminal or the user terminal via a predetermined orchestration device.

6. A management device arranged in a virtual network system that includes: a first physical network in which a plurality of virtual networks are constructed; a base station of a Mobile Virtual Network Operator that provides a communication service using a mobile communication service provided by a mobile network operator to a user terminal; and a second physical network that connects the first physical network and the base station of a Mobile Virtual Network Operator,
wherein information related to the user terminal to access to the first physical network using a mobile communication service provided by the Mobile Virtual Network Operator is set to a first device and a second device, the first device authenticates the user terminal, the second device authorizes access by the user terminal succeeded in the authentication to a first virtual network in the first physical network according to the authentication result via a second virtual network constructed in the second physical network.

7. The management device according to claim 6, further comprising a fourth device that constructs the second virtual network related to the first virtual network of the first physical network in the second physical network.

8. The management device according to claim 6, wherein the management device notifies information in a Subscriber Identity Module (SIM) card of the user terminal to a gateway in the base station in the Mobile Virtual Network Operator having an access point name designated by the user terminal, in addition to a configuration that sets information related to the user terminal to the first device and the second device.

9. The management device according to claim 8, further comprising a virtualization server that provides a virtual network function for each virtual network,
wherein the virtual network function is made possible to be booted from a network management terminal or the user terminal via a predetermined orchestration device.

10. A management method of a virtual network comprising:
by a management device of a virtual network system,
setting information about a user terminal to a first device and a second device, the first device authenticating the user terminal to access to a first physical network using the mobile communication service provided by the Mobile Virtual Network Operator, the second device authorizing the user terminal that succeeded in the authentication to access to a first virtual network in the first physical network according to the authentication result via a second virtual network constructed in the second physical network,
wherein the virtual network system includes: the first physical network in which a plurality of virtual networks are constructed; a base station of the Mobile Virtual Network Operator that provides a communication service using the mobile communication service provided by a mobile network operator to the user terminal; and the second physical network that connects the first physical network and the base station of the Mobile Virtual Network Operator.

11. (canceled)
